(19) United States
(12) Patent Application Publication
(10) Pub. No.: US 2004/0176510 A1
(43) Pub. Date: Sep. 9, 2004

(54) Flameproofed thermoplastic molding compounds

(76) Inventor: Michael Geprags, Weisenheim (DE)

Correspondence Address: KEIL & WEINKAUF, 1350 CONNECTICUT AVENUE, N.W., WASHINGTON, DC, 20036, US

(21) Appl. No.: 10/482,217

(22) PCT Filed: Jul. 3, 2002
(86) PCT No.: PCT/EP02/07338

(30) Foreign Application Priority Data
Jul. 5, 2001 (DE) 101 32 056.6

(51) Int. Cl. C08K 3/10; C08K 3/32; C08K 5/02

(52) U.S. Cl. 524/409; 524/464; 524/417

(57) ABSTRACT

Thermoplastic molding compositions comprising

A) from 10 to 97% by weight of at least one polyester a₁) other than polyethylene terephthalate (PET), which comprises, based on 100% by weight of A), from 1 to 50% by weight of PET a₂),

B) from 1 to 30% by weight of a flame retardant combination made from, based on 100% by weight of B),

b₁) from 20 to 99% by weight of a halogen-containing flame retardant, and

b₂) from 1 to 80% by weight of an antimony oxide,

C) from 0.01 to 5% by weight of KH₂PO₄ or LiH₂PO₄, or a mixture of these

D) from 0.01 to 3% by weight of an antidrop agent, and

E) from 0 to 70% by weight of other additives, where the total of the percentages by weight of components A) to E) is 100%.

The invention relates to thermoplastic molding compositions comprising

A) from 10 to 97% by weight of at least one polyester a₁) other than polyethylene terephthalate (PET), which comprises, based on 100% by weight of A), 1 to 50% by weight of PET a₂),

B) from 1 to 30% by weight of a flame retardant combination made from, based on 100% by weight of B),

b₁) from 20 to 99% by weight of a halogen-containing flame retardant, and

b₂) from 1 to 80% by weight of an antimony oxide,

C) from 0.01 to 5% by weight of KH₂PO₄ or LiH₂PO₄, or a mixture of these

D) from 0.01 to 3% by weight of an antidrop agent, and

E) from 0 to 70% by weight of other additives, where the total of the percentages by weight of components A) to E) is 100%.

The invention further relates to the use of the molding compositions of the invention for producing fibers, films or moldings, and also to the resultant moldings of any type.

U.S. Pat. No. 4,532,290 and U.S. Pat. No. 3,953,539 disclose PC/polyester blends which comprise phosphates as inhibitors for transesterification and, respectively, as color stabilizers.

EP-A 543 128 discloses blends of this type which may also comprise halogenated polycarbonates, with transesterification inhibitors based on zinc dihydrogenphosphate or calcium dihydrogenphosphate.

There continue to be problems in industry with the crystallization behavior and the flowability of molding compositions based on halogen-containing, in particular low-molecular-weight, poly- or oligocarbonates used as flame retardants for polyesters. A transesterification reaction between polycarbonate and polyester forms block copolymers which have a broad molecular weight distribution and poorer crystallization behavior. This is particularly apparent in the rapidly thawing crystallization temperature, and there is therefore an adverse effect on injection molding and on blow molding.

It is an object of the present invention, therefore, to provide flame-retardant polyester molding compositions which have improved crystallization behavior during processing, and also better flowability.

We have found that this object is achieved by means of the molding compositions defined at the outset. Preferred embodiments are given in the subclaims.

Surprisingly, this combination in particular of oligomeric halogen-containing flame retardants with polyesters leads to crystallization behavior in which a high crystallization temperature is retained over a prolonged period with repeated melting. Associated with this is a shorter cycle time and shorter demolding times, and also reduced tendency toward adhesion.

The molding compositions of the invention comprise, as component A), from 10 to 97% by weight, preferably from 20 to 97% by weight, and in particular from 30 to 80% by weight, of a polyester other than polyethylene terephthalate (PET), which comprises, based on 100% by weight of A), from 1 to 50% by weight, preferably from 10 to 35% by weight, of PET.

Suitable polyethylene terephthalate (a₂) derive from the aliphatic dihydroxy compound ethylene glycol and the aromatic dicarboxylic acid terephthalic acid, and up to 10 mol % of the aromatic dicarboxylic acid here may have been replaced by other aromatic dicarboxylic acids, such as 2,6-naphthalenedicarboxylic acid or isophthalic acid, or a mixture of these, or by aliphatic or cycloaliphatic dicarboxylic acids, such as adipic acid, azelaic acid, or cyclohexanedicarboxylic acid. Ethylene glycol in the polyethylene terephthalate may also have been replaced by, for example, 1,6-hexanediol and/or 5-methyl-1,5-pentanediol in amounts of up to 0.75% by weight, based on the total weight of polyethylene terephthalate used.

The viscosity number of the polyethylene terephthalate of the invention is generally in the range from 40 to 120 ml/g, and preferably from 60 to 100 ml/g (determined to ISO 1628 in a 0.5% strength by weight solution in a phenol/o-dichlorobenzene mixture (1:1) at 25° C.).

The carboxy end group content of the polyethylene terephthalate which may be used is generally not greater than 60 mval/kg, preferably not greater than 40 mval/kg, and in particular not greater than 30 mval/kg. The carboxy end group content is usually determined by titration methods (e.g. by means of potentiometry).

The polyethylene terephthalates used may also be mixtures of these compounds differing in viscosity number and carboxy end group content.

The polyethylene terephthalate of the invention is obtained by known processes using catalysts which accelerate the transesterification reaction and where appropriate also the polycondensation reaction. Examples of suitable catalysts are inorganic or organic Lewis-acid metal compounds, e.g. those based on the metallic elements of groups IB, IIB, IVA, IVB, VA, VB or VIIIB of the Periodic Table of the Elements. Examples of those which may be used are the catalytically active organic and inorganic titanium compounds, tin compounds, and antimony compounds mentioned in the U.S. Pat. No. 3,936,421. Organic tin compounds and organic titanium compounds are particularly suitable, for example tetraethyltin, dibutyltin dichloride, dibutyltin maleate, dibutyltin laurate, tetrabutyl orthotitanate, tetraoctyl titanate, and triethanolamine titanate.

It is also advantageous to use recycled PET materials (also termed scrap PET) in a mixture with polyesters, such as polyalkylene terephthalates, e.g. PBT.

Recycled materials are generally:

1) those known as post-industrial recycled materials: these are production wastes during polycondensation or during processing, e.g. sprues from injection molding, start-up material from injection molding or extrusion, or edge trims from extruded sheets or films.

2) post-consumer recycled materials: these are plastic items which are collected and treated after utilization by the end consumer. Blow-molded PET bottles for mineral water, soft drinks and juices are easily the predominant items in terms of quantity.

Both types of recycled material may be used either as ground material or in the form of pellets. In the latter case, the crude recycled materials are isolated and purified and then melted and pelletized using an extruder. This usually facilitates handling and free flow, and metering for further steps in processing.

The recycled materials used may either be pelletized or in the form of regrind. The edge length should not be more than 6 mm, preferably less than 5 mm.

Because polyesters undergo hydrolytic cleavage during processing (due to traces of moisture) it is advisable to predry the recycled material. The residual moisture after drying is preferably <0.2% in particular <0.05%.

The polyesters a₁) other than PET which are generally used are based on aromatic dicarboxylic acids and on an aliphatic or aromatic dihydroxy compound.

A first group of preferred polyesters is that of polyalkylene terephthalates preferably having from 2 to 10 carbon atoms in the alcohol moiety.

Polyalkylene terephthalates of this type are known per se and are described in the literature. Their main chain contains an aromatic ring which derives from the aromatic dicarboxylic acid. The aromatic ring may also have substitution, e.g. by halogen, such as chlorine or bromine, or by C₁-C₄-alkyl, such as methyl, ethyl, isopropyl, n-propyl, n-butyl, isobutyl, or tert-butyl groups.

These polyalkylene terephthalate may be prepared by reacting aromatic dicarboxylic acids, or their esters or other ester-forming derivatives, with aliphatic dihydroxy compounds, in a manner known per se.

Preferred dicarboxylic acids which should be mentioned are 2,6-naphthalenedicarboxylic acid, terephthalic acid and isophthalic aid, and mixtures of these. Up to 30 mol %, preferably not more than 10 mol %, of the aromatic dicarboxylic acids may be replaced by aliphatic or cycloaliphatic dicarboxylic acids, such as adipic acid, azelaic acid, sebacic acid, dodecanedioic acids, or cyclohexanedicarboxylic acids.

Among the aliphatic dihydroxy compounds, preference is given to diols having from 2 to 6 carbon atoms, in particular 1,2-ethanediol, 1,3-propanediol, 1,4-butanediol, 1,6-hexanediol, 1,4-hexanediol, 1,4-cyclohexanediol, 1,4-cyclohexanedimethylanol, and neopentyl glycol, and mixtures of these.

Particularly preferred polyesters (A) are polyalkylene terephthalates which derive from alkanediols having from 3 to 6 carbon atoms. Among these, particular preference is given to polypropylene terephthalate and polybutylene terephthalate and mixtures of these. Preference is also given to PPT and/or PBT which contain up to 1% by weight, preferably up to 0.75% by weight, 1,6-hexanediol and/or 2-methyl-1,5-pentanediol as other monomer units.

The viscosity number of the polyesters (A) is generally in the range from 50 to 220, preferably from 80 to 160 (measured in a 0.5% strength by weight solution in a phenol/o-dichlorobenzene mixture (ratio by weight 1:1 at 25° C.) to ISO 1628.

Particular preference is given to polyesters whose carboxy end group content is up to 100 mval/kg of polyester, preferably up to 60 mval/kg of polyester, and in particular up to 50 mval/kg of polyester. One way of preparing polyesters of this type is to use the process of DE-A 44 01 055. The carboxy end group content is usually determined by titration methods (e.g. potentiometry).

In the particularly preferred embodiment of A) the PBT:PET ratio is preferably from 3:1 to 1.5:1, in particular from 2.5:1 to 2:1.

Another group which should be mentioned is that of fully aromatic polyesters which derive from aromatic dicarboxylic acids and from aromatic dihydroxy compounds.

Suitable aromatic dicarboxylic acids are the compounds described above under the polyalkylene terephthalates. Preference is given to mixtures made from 5-100 mol % of isophthalic acid and 0-95 mol % of terephthalic acid, in particular mixtures of from about 80 to 50% of terephthalic acid with from 20 to 50% of isophthalic acid.

The aromatic dihydroxy compounds preferably have the formula

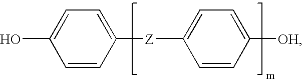

where Z is alkylene or cycloalkylene having up to 8 carbon atoms, arylene having up to 12 carbon atoms, carbonyl, sulfonyl, oxygen or sulfur, or a chemical bond, and m is from 0 to 2. The phenylene groups of the compounds I may also have substitution by C₁-C₆-alkyl or alkoxy and fluorine, chlorine or bromine.

Examples of parent substances for these compounds are

dihydroxydiphenyl,

di(hydroxyphenyl)alkane,

di(hydroxyphenyl)cycloalkane,

di(hydroxyphenyl) sulfide,

di(hydroxyphenyl) ether,

di(hydroxyphenyl) ketone,

di(hydroxyphenyl) sulfoxide,

α,α′-di(hydroxyphenyl)dialkylbenzene,

di(hydroxyphenyl) sulfone, di(hydroxybenzoyl)benzene resorcinol and

hydroquinone and also the ring-alkylated and ring-halogenated derivatives of these.

Among these, preference is given to

4,4,′-dihydroxydiphenyl,

2,4-di(4′-hydroxyphenyl)-2-methylbutane,

α,α′-di(4-hydroxyphenyl)-p-diisopropylbenzene,

2,2-di(3′-methyl-4′-hydroxyphenyl)propane and

2,2-di(3′-chloro-4′-hydroxyphenyl)propane,

and in particular to

2,2-di(4′-hydroxyphenyl)propane,

2,2-di(3′,5-dichlorodihydroxyphenyl)propane,

1,1-di(4′-hydroxyphenyl)cyclohexane,

3,4′-dihydroxybenzophenone,

4,4′-dihydroxydiphenylsulfone and

2,2-di(3′,5′-dimethyl-4′-hydroxyphenyl)propane

or mixtures of these.

It is, of course, also possible to use mixtures of polyalkylene terephthalates and fully aromatic polyesters. These generally comprise from 20 to 98% by weight of the polyalkylene terephthalate and from 2 to 80% by weight of the fully aromatic polyester.

It is, of course, also possible to use polyester block copolymers, such as copolyetheresters. Products of this type are known per se and are described in the literature, e.g. in U.S. Pat. No. 3,651,014. Corresponding products are also available commercially, e.g. Hytrel® (DuPont).

The molding compositions of the invention comprise, as component B), from 1 to 30% by weight, preferably from 2 to 25% by weight, and in particular from 5 to 20% by weight, of a flame retardant combination made from

b₁) from 20 to 99% by weight, preferably from 50 to 85% by weight, of a halogen-containing flame retardant, preferably having a degree of polymerization or degree of oligomerization >3, preferably >4, and

b₂) from 1 to 80% by weight, preferably from 15 to 50% by weight, of an antimony oxide.

Preferred oxides b₂) are antimony trioxide and antimony pentoxide. To improve dispersion, the oxide b₂) may be incorporated into the polymer A) within what are known as masterbatches (concentrates). Examples of thermoplastics which may be used in the concentrate are those identical with component A) and those other than the component A) used. Preference is given to concentrates of b₂) in polyolefins, preferably polyethylene.

Suitable flame retardants b₁) are preferably brominated compounds, such as brominated oligocarbonates (BC 52 or BC 58 from the company Great Lakes, or FG 7000 from the company Teijin Chem.) of the structural formula:

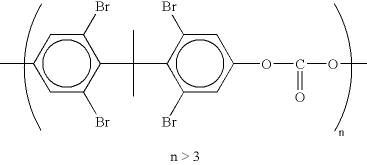

Other suitable compounds are polypentabromobenzyl acrylates where n>4 (e.g. FR 1025 from the company Dead Sea Bromine (DSB)) of the formula:

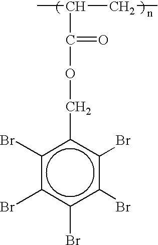

Other preferred brominated compounds are oligomeric reaction products (n>3) of tetrabromobisphenol A with epoxides (e.g. FR 2300 and 2400 from the company DSB) of the formula:

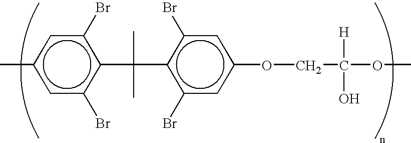

The brominated oligostyrenes preferably used as flame retardants have an average degree of polymerization (number-average) of from 4 to 90, preferably from 5 to 60, measured by vapor pressure osmometry in toluene. Cyclic oligomers are also suitable. In one preferred embodiment of the invention, the brominated oligomeric styrenes to be used have the formula I below, where R is hydrogen or an aliphatic radical, in particular alkyl, e.g. CH₂ or C₂H₅, and n is the number of repeat units in the chain. R′ may be either H or bromine, or else a fragment of a conventional free-radical generator:

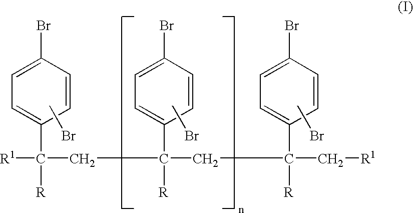

n may be from 4 to 88, preferably from 4 to 58. The brominated oligostyrenes contain from 40 to 80% by weight, preferably from 55 to 70% by weight, of bromine. Preference is given to a product composed mainly of polydibromostyrene. The substances can be melted without decomposition and are soluble in tetrahydrofuran, for example. They may be prepared either by ring-bromination of—where appropriate aliphatically hydrogenated—styrene oligomers, e.g. those obtained by thermal polymerization of styrene (in accordance with DT-A [sic] 25 37 385) or by free-radical oligomerization of suitable brominated styrenes. The flame retardant may also be prepared by ionic oligomerization of styrene followed by bromination. The amount of brominated oligostyrene needed to provide the polyesters with flame retardancy depends on the bromine content. The bromine content in the molding compositions of the invention is from 2 to 20% by weight, preferably from 5 to 12% by weight.

The brominated polystyrenes of the invention are usually obtained by the process described in EP-A 47 549:

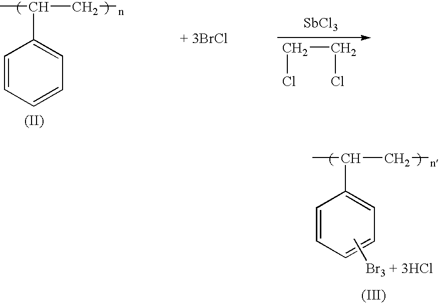

The brominated polystyrenes obtainable by this process and obtainable commercially are mainly ring-substituted tribrominated products. n′ (see III) is generally from 120 to 2000, corresponding to a molecular weight of from 40000 to 1000000, preferably from 130000 to 800000.

The bromine content (based on the content of ring-substituted bromine) is generally at least 55% by weight, preferably at least 60% by weight, and in particular 68% by weight.

The commercially available pulverulent products generally have a glass transition temperature of from 160 to 200° C., and examples of the names of those available are HP 7010 from the company Albemarle and Pyrocheck® PB 68 from the company Ferro Corporation, and Saytex 7010 from the company Albemarle.

It is also possible to use mixtures of the brominated oligostyrenes with brominated polystyrenes in the molding compositions of the invention, and the mixing ratio here may be as desired.

The degree of polymerization n may usually be determined by determining the molecular weight.

This corresponds to a molecular weight (Mₙ)>2000, which can generally be determined by means of membrane osmometry or by light scattering for M_{w}>10000.

Chlorine-containing flame retardants b₁) are also suitable, and preference is given to Dechlorane® plus from the company Oxychem.

As component C, the molding compositions of the invention comprise KH₂PO₄ or LiH₂PO₄, or a mixture of these, in amounts of from 0.01 to5% by weight, preferably from 0.05 to 2% by weight, and in particular from 0.05 to 0.5% by weight.

KH₂PO₄: CAS No. 7778-77-0

LiH₂PO₄: CAS No. 13453-80-0

Preparation processes are known to the skilled worker, and no further information on that topic is therefore required. The products available commercially (e.g. Chemische Fabrik Budenheim, Sigma-Aldrich Chemie), are generally white solids.

The molding compositions of the invention comprise from 0.01 to 3% by weight, preferably from 0.05 to 2% by weight, and in particular from 0.1 to 1% by weight, of an antidrop agent D), such as fluorinated ethylene polymers. These are ethylene polymers having a fluorine content of from 55 to 76% by weight, preferably from 70 to 76% by weight.

Examples of these are polytetrafluoroethylene (PTFE), tetrafluoroethylene-hexafluoropropylene copolymers, and tetrafluoroethylene copolymers having relatively small proportions (generally up to 50% by weight) of copolymerizable ethylenically unsaturated monomers. Examples of descriptions of these are found in “Vinyl and Related Polymers”, Wiley-Verlag, 1952, pp. 484-494 and by Wall in “Fluorpolymers” (Wiley Interscience, 1972).

These fluorine-containing ethylene polymers have homogeneous distribution in the molding compositions and preferably have a particle size d₅₀ (numeric median) in the range from 0.05 to 10 μm, in particular from 0.1 to 5 μm. The small particle sizes may particularly preferably be achieved by using aqueous dispersions of fluorine-containing ethylene polymers and incorporating these into a polyester melt.

It is also possible for the fluorine-containing ethylene polymers to be in the form of a masterbatch (e.g. up to 5% by weight in PBT). Another preferred form is (pulverulent or compacted) PTFE encapsulated by styrene-acrylonitrile copolymers, in particular by PSAN, this form permitting very fine distribution of the fluorine-containing ethylene polymers. An example of this product is marketed by the company GE Speziality with the name Blendex® 449.

The molding compositions of the invention may comprise, as component E), from 0 to 70% by weight, in particular up to 50% by weight, of other additives.

The molding compositions of the invention may comprise, as component E) from 0 to 5% by weight, in particular from 0.01 to 5% by weight, preferably from 0.05 to 3% by weight, and in particular from 0.1 to 2% by weight, of at least one ester or amide or saturated or unsaturated aliphatic carboxylic acid having from 10 to 40 carbon atoms, preferably from 16 to 22 carbon atoms, with saturated aliphatic alcohols or amines having from 2 to 40 carbon atoms, preferably from 2 to 6 carbon atoms.

The carboxylic acids may be mono- or dibasic. Examples are pelargonic acid, palmitic acid, lauric acid, margaric acid, dodecanedioic acid, behenic acid and, particularly preferably, stearic acid, capric acid and montanic acid (a mixture of fatty acids having from 30 to 40 carbon atoms).

The aliphatic alcohols may be mono- to tetrahydric. Examples of alcohols are n-butanol, n-octanol, stearyl alcohol, ethylene glycol, propylene glycol, neopentyl glycol and pentaerythritol. Glycerol and pentaerythritol are preferred.

The aliphatic amines may be mono- to tribasic. Examples of these are stearylamine, ethylenediamine, propylenediamine, hexamethylenediamine and di(6-aminohexyl) amine. Ethylenediamine and hexamethylenediamine are particularly preferred. Correspondingly, preferred esters or amides are glycerol distearate, glycerol tristearate, ethylenediamine distearate, glycerol monopalmitrate [sic], glycerol trilaurate, glycerol monobehenate and pentaerythritol tetrastearate.

It is also possible to use mixtures of different esters or amides or combinations of esters with amides. The mixing ratio may be as desired. A particularly advantageous method is to add, based on A), from 0.1 to 0.8% by weight, in particular from 0.5 to 0.7% by weight, of this component E) once at least 80% of the desired final viscosity of component a₁ and/or a₂ has been achieved and then to compound with the other components B) to E).

Examples of other additives E) are up to 40% by weight, preferably up to 30% by weight, of elastomeric polymers (also frequently termed impact modifiers, elastomers or rubbers).

These are very generally copolymers preferably built up from at least two of the following monomers: ethylene, propylene, butadiene, isobutene, isoprene, chloroprene, vinyl acetate, styrene, acrylonitrile and (meth)acrylates having from 1 to 18 carbon atoms in the alcohol component.

Polymers of this type have been described, for example, in Houben-Weyl, Methoden der organischen Chemie, Vol. 14/1 (Georg-Thieme-Verlag, Stuttgart, 1961), pages 392-406, and in the monograph by C. B. Bucknall, “Toughened Plastics” (Applied Science Publishers, London, 1977).

Some preferred types of such elastomers are described below.

Preferred types of such elastomers are those known as ethylene-propylene (EPM) and ethylene-propylene-diene (EPDM) rubbers.

EPM rubbers generally have practically no residual double bonds, whereas EPDM rubbers may have from 1 to 20 double bonds per 100 carbon atoms.

Examples which may be mentioned of diene monomers for EPDM rubbers are conjugated dienes, such as isoprene and butadiene, non-conjugated dienes having from 5 to 25 carbon atoms, such as 1,4-pentadiene, 1,4-hexadiene, 1,5-hexadiene, 2,5-dimethyl-1,5-hexadiene and 1,4-octadiene, cyclic dienes, such as cyclopentadiene, cyclohexadienes, cyclooctadienes and dicyclopentadiene, and also alkenylnorbornenes, such as 5-ethylidene-2-norbornene, 5-butylidene-2-norbornene, 2-methallyl-5-norbornene and 2-isopropenyl-5-norbornene, and tricyclodienes, such as 3-methyltricyclo(5.2.1.0.2.6)-3,8-decadiene [sic], or mixtures of these. Preference is given to 1,5-hexadiene, 5-ethylidenenorbornene and dicyclopentadiene. The diene content of the EPDM rubbers is preferably from 0.5 to 50% by weight, in particular from 1 to 8% by weight, based on the total weight of the rubber.

EPM and EPDM rubbers may preferably also have been grafted with reactive carboxylic acids or with derivatives of these. Examples of these are acrylic acid, methacrylic acid and derivatives thereof, e.g. glycidyl (meth)acrylate, and also maleic anhydride.

Copolymers of ethylene with acrylic acid and/or methacrylic acid and/or with the esters of these acids are another group of preferred rubbers. The rubbers may also include dicarboxylic acids, such as maleic acid and fumaric acid, or derivatives of these acids, e.g. esters and anhydrides, and/or monomers containing epoxy groups. These monomers containing dicarboxylic acid derivatives or containing epoxy groups are preferably incorporated into the rubber by adding to the monomer mixture monomers containing dicarboxylic acid groups and/or epoxy groups and having the formula I, II, III or IV

R¹C(COOR²)═C(COOR³)R⁴ (I)

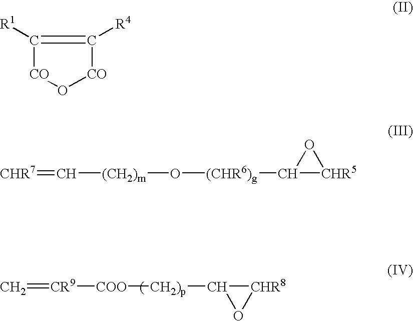

where R¹ to R⁹ are hydrogen or alkyl having from 1 to 6 carbon atoms, and m is an integer from 0 to 20, g is an integer from 0 to 10 and p is an integer from 0 to 5.

R¹ to R⁹ are preferably hydrogen, where m is 0 or 1 and g is 1. The corresponding compounds are maleic acid, fumaric acid, maleic anhydride, allyl glycidyl ether and vinyl glycidyl ether.

Preferred compounds of the formulae I, II and IV are maleic acid, maleic anhydride and (meth)acrylates containing epoxy groups, such as glycidyl acrylate and glycidyl methacrylate, and the esters with tertiary alcohols, such as tert-butyl acrylate. Although the latter have no free carboxyl groups their behavior approximates to that of the free acids and they are therefore termed monomers with latent carboxyl groups.

The copolymers are advantageously composed of from 50 to 98% by weight of ethylene, from 0.1 to 20% by weight of monomers containing epoxy groups and/or methacrylic acid and/or monomers containing anhydride groups, the remaining amount being (meth)acrylates.

Particular preference is given to copolymers composed of

from 50 to 98% by weight, in particular from 55 to 95% by weight, of ethylene,

from 0.1 to40% by weight, in particular from 0.3 to 20% by weight, of glycidyl acrylate and/or glycidyl methacrylate, (meth)acrylic acid and/or maleic anhydride, and

from 1 to 45% by weight, in particular from 10 to 40% by weight, of n-butyl acrylate and/or 2-ethylhexyl acrylate.

Other preferred (meth)acrylates are the methyl, ethyl, propyl, isobutyl and tert-butyl esters.

Besides these, comonomers which may be used are vinyl esters and vinyl ethers.

The ethylene copolymers described above may be prepared by processes known per se, preferably by random copolymerization at high pressure and elevated temperature. Appropriate processes are well known.

Other preferred elastomers are emulsion polymers whose preparation is described, for example, by Blackley in the monograph “Emulsion Polymerization”. The emulsifiers and catalysts which may be used are known per se.

In principle, either elastomers with a homogeneous structure or those with a shell structure may be employed. The shell-type structure is a function of the addition sequence of the individual monomers. The morphology of the polymers is also influenced by this addition sequence.

Compounds which may be mentioned merely as examples of monomers for preparing the elastic part of the elastomers are acrylate, for example n-butyl acrylate and 2-ethylhexyl acrylate, the corresponding methacrylates, butadiene and isoprene, and mixtures of these. These monomers may be copolymerized with other monomers, such as styrene, acrylonitrile, vinyl ethers, and with other acrylates, methacrylates, such as methyl methacrylate, methyl acrylate, ethyl acrylate, or propyl acrylate.

The soft or rubber phase (with a glass transition temperature less than 0° C.) of the elastomers can be the core, the outer envelope, or an intermediate shell (in elastomers whose structure has more than two shells). Elastomers having two or more shells may also have two or more shells made from a rubber phase.

If one or more hard components (with glass transition temperatures of greater than 20° C.) are involved, besides the rubber phase,, in the structure of the elastomer, these are generally prepared by polymerization of styrene, acrylonitrile, methacrylonitrile, α-methylstyrene, p-methylstyrene, or of acrylates or methacrylates, such as methyl acrylate, ethyl acrylate, or methyl methacrylate, as main monomers. Besides these, smaller amounts of other comonomers may also be employed.

In a number of cases, it has proven advantageous to employ emulsion polymers having reactive groups at the surface. Examples of groups of this type are epoxy, carboxy, latent carboxy, amino, and amide groups, and functional groups which can be introduced by incorporation of monomers of the formula

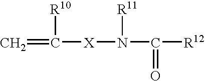

where

R¹⁰ is hydrogen or C₁-C₄-alkyl,

R¹¹ is hydrogen, C₁-C₈-alkyl, or aryl, in particular phenyl,

R¹² is hydrogen, C₁-C₁₀-alkyl, C₆-C₁₂-aryl, or —OR¹³

R¹³ is C₁-C₈-alkyl or C₆-C₁₂-aryl, each of which may have been substituted with oxygen- or nitrogen-containing groups,

X is a chemical bond, C₁-C₁₀-alkylene, or C₆-C₁₂-arylene, or

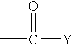

Y is O-Z or NH-Z, and

Z is C₁-C₁₀-alkylene or C₆-C₁₂-arylene.

The graft monomers described in EP-A 208 187 are also suitable for introducing reactive groups on the surface.

Other examples are acrylamide, methacrylamide, and substituted acrylates and methacrylates, such as (N-tert-butylamino)ethyl methacrylate, (N,N-dimethylamino)ethyl acrylate, (N,N-dimethylamino)methyl acrylate and (N,N-diethylamino)ethyl acrylate.

The constituents of the rubber phase may also have been crosslinked. Examples of monomers which act as crosslinkers are 1,3-butadiene, divinylbenzene, diallyl phthalate, dihydrodicyclopentadienyl acrylate, and the compounds described in EP-A 50 265.

Use may also be made of graft-linking monomers, i.e. monomers having two or more polymerizable double bonds which react at different rates during polymerization. Preference is given to compounds of this type in which at least one reactive group polymerizes at about the same rate as the remaining monomers, whereas the other reactive group(s), for example, polymerize(s) significantly more slowly. The different polymerization rates give rise to a certain proportion of unsaturated double bonds in the elastomer. If a further phase is then grafted onto an elastomer of this type, at least some of the double bonds in the elastomer react to form chemical bonds with the graft monomers, i.e. the grafted phase has at least some extent of linkage via chemical bonds to the graft base.

Examples of graft-linking monomers of this type are allyl-containing monomers, in particular allyl esters of ethylenically unsaturated carboxylic acids, for example allyl acrylate, allyl methacrylate, diallyl maleate, diallyl fumarate, diallyl itaconate, and the corresponding monoallyl compounds of these dicarboxylic acids. There are also many other suitable graft-linking monomers, and further details may be found in U.S. Pat. No. 4,148,846, for example.

The proportion of these crosslinking monomers in the impact-modified polymer is generally up to 5% by weight, preferably not more than 3% by weight, based on the impact-modified polymer.

Instead of graft polymers having a structure of two or more shells, it is also possible to use homogeneous, i.e. single-shell, elastomers made from 1,3-butadiene, isoprene, and n-butyl acrylate, or copolymers of these. These products may also be prepared with incorporation of crosslinking monomers or of monomers having reactive groups.

Examples of preferred emulsion polymers are n-butyl acrylate-(meth)acrylic acid copolymers, n-butyl acrylate-glycidyl acrylate copolymers, n-butyl acrylate-glycidyl methacrylate copolymers, graft polymers having an inner core made from n-butyl acrylate or based on butadiene and having an outer envelope made from the abovementioned copolymers, and copolymers of ethylene with comonomers which supply reactive groups.

The elastomers described may also be prepared by other conventional processes, e.g. by suspension polymerization.

Preference is also given to silicone rubbers, as described in DE-A 37 25 576, EP-A 235 690, DE-A 38 00 603 and EP-A 319 290.

It is, of course, also possible to use mixtures of the types of rubber listed above.

Examples of fibrous or particulate fillers (component E)) are carbon fibers, glass fibers, glass beads, amorphous silica, asbestos, calcium silicate, calcium metasilicate, magnesium carbonate, kaolin, chalk, powdered quartz, mica, barium sulfate and feldspar, used in amounts of up to 50% by weight, and in particular from 1 to 50% by weight, preferably from 5 to 40% by weight, particularly from 15 to 35% by weight.

Preferred fibrous fillers are carbon fibers, aramid fibers and potassium titanate fibers, and particular preference is given to glass fibers in the form of E glass. These may be used as rovings or chopped glass in the commercially available forms.

The fibrous fillers may have been surface-pretreated with a silane compound to improve compatibility with the thermoplastic.

Suitable silane compounds have the formula

(X—(CH₂)ₙ)ₖ—Si—(O—CₘH₂ₘ₊₁)₄₋ₖ

where:

X NH₂—,

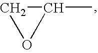

HO—,

n is an integer from 2 to 10, preferably 3 or 4

m is an integer from 1 to 5, preferably 1 or 2, and

k is an integer from 1 to 3, preferably 1.

Preferred silane compounds are aminopropyltrimethoxysilane, aminobutyltrimethoxysilane, aminopropyltriethoxysilane and aminobutyltriethoxysilane, and also the corresponding silanes which contain a glycidyl group as substituent X.

The amounts of the silane compounds generally used for surface-coating are from 0.05 to 5% by weight, preferably from 0.5 to 1.5% by weight and in particular from 0.8 to 1% by weight (based on E).

Acicular mineral fillers are also suitable.

For the purposes of the invention, acicular mineral fillers are mineral fillers with strongly developed acicular character. An example which may be mentioned is acicular wollastonite. The mineral preferably has an L/D (length to diameter) ratio of from 8:1 to 35:1, preferably from 8:1 to 11:1. The mineral filler may, if desired, have been pretreated with the abovementioned silane compounds, but the pretreatment is not essential.

Other fillers which may be mentioned are kaolin, calcined kaolin, wollastonite, talc and chalk.

The thermoplastic molding compositions of the invention may comprise, as component E), conventional processing aids, such as stabilizers, oxidation retarders, agents to counter thermal decomposition and decomposition by ultraviolet light, lubricants, mold-release agents, colorants, such as dyes and pigments, nucleating agents, plasticizers, etc. other than component C).

UV stabilizers which should be mentioned and are usually used in amounts of up to 2% by weight, based on the molding composition, are various substituted resorcinols, salicylates, benzotriazoles and benzophenones.

Suitable stabilizers are preferably organic phosphonites E) of the formula I

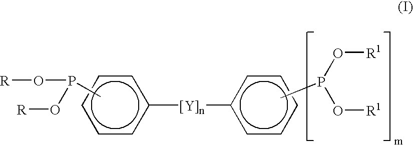

where

m is 0 or 1,

n is 0 or 1,

Y is an oxygen bridge, a sulfur bridge or a 1,4-phenylene bridge, or a bridging unit of the formula —CH(R²)—; each of the R—O— and R¹—O— groups, independently of one another, is the radical of an aliphatic, alicyclic or aromatic alcohol which may contain up to three hydroxyl groups, but excluding any arrangement of the hydroxyl groups which permits these to be part of a phosphorus-containing ring (termed monovalent R—O— groups),

or two R—O— or, respectively, R¹—O— groups, bonded to a phosphorus atom, in each case independently of one another, together are the radical of an aliphatic, alicyclic or aromatic alcohol having a total of up to three hydroxyl groups (termed bivalent R—O—, or, respectively, R¹—O— groups),

R² is hydrogen, C₁-C₈-alkyl or a group of the formula COOR³, and

R³ is C₁₋₈-alkyl.

It is preferable for at least one R—O and at least one R¹—O group to be a phenol radical which carries a sterically hindered group, in particular t-butyl, in the 2 position.

Particular preference is given to tetrakis(2,4-di-tert-butylphenyl) biphenylenediphosphonite, which is available commercially from Ciba Geigy AG as Irgaphos® PEPQ.

If R—O— and R¹—O— are bivalent radicals, they preferably derive from di- or trihydric alcohols.

R is preferably identical with R¹ and is alkyl, aralkyl (preferably unsubstituted or substituted phenyl or phenylene), aryl (preferably unsubstituted or substituted phenyl), or a group of the formula α

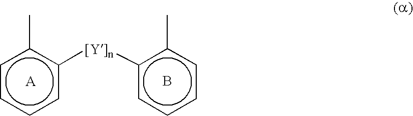

where the rings A and B may bear other substituents and Y′ is an oxygen bridge or a sulfur bridge or a bridging unit of the formula —CH(R³)—,

R² is hydrogen, C₁-C₈-alkyl, or a group of the formula —COOR³, and

R³ is C₁₋₈-alkyl, and

n is 0 or 1 (termed bivalent R′).

Particularly preferred radicals R are the radicals R″, where this may bear [sic] C₁₋₂₂-alkyl, phenyl, which may carry from 1 to 3 substituents selected from the class consisting of cyano, C₁₋₂₂-alkyl, C₁₋₂₂-alkoxy, benzyl, phenyl, 2,2,6,6-tetramethylpiperidyl-4-, hydroxyl, C₁₋₈-alkylphenyl, carboxy, —C(CH₃)₂—C₆H₅, —COO—C₁₋₂₂-alkyl, —CH₂CH₁₂—COOH, —CH₂CH₂COO—, C₁₋₂₂-alkyl or —CH₂—S—C₁₋₂₂-alkyl; or a group of the formula i to vii.

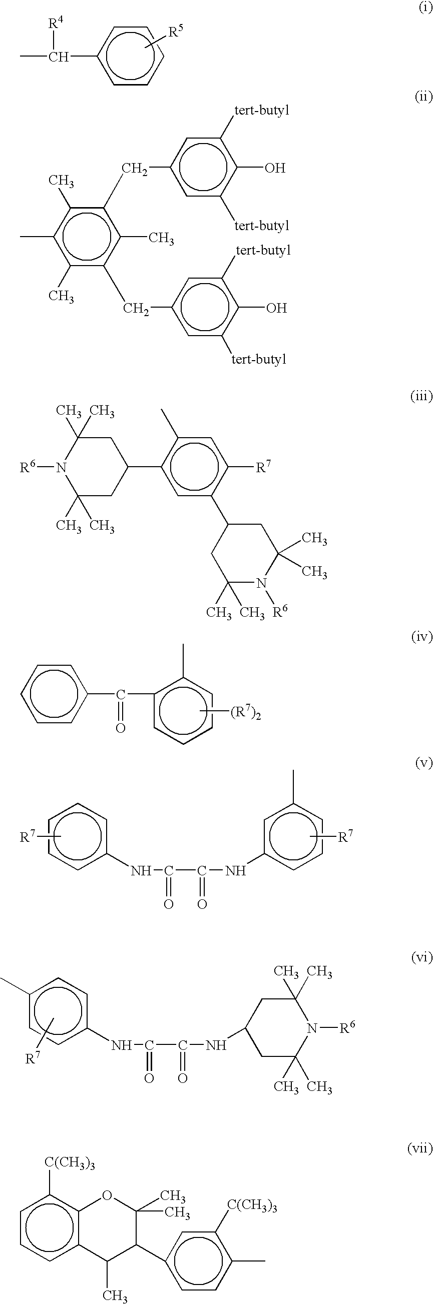

or two R″ together are a group of the formula viii

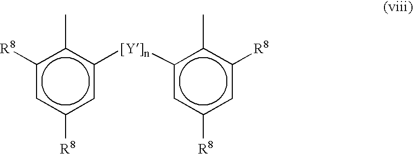

where

R⁸ is hydrogen or C₁₋₂₂-alkyl,

R⁶ is hydrogen, C₁₋₄-alkyl or —CO—C₁₋₈-alkyl,

R⁴ is hydrogen or C₁₋₂₂-alkyl,

R⁵ is hydrogen, C₁₋₂₂-alkyl, C₁₋₂₂-alkoxy, benzyl, cyano, phenyl, hydroxyl, C₁₋₈-alkylphenyl, C₁₋₂₂-alkoxycarbonyl, C₁₋₂₂-alkoxycarbonylethyl, carboxyethyl, 2,2,6,6-tetramethylpiperidyl-4-, or a group of the formula —CH₂—S—C₁₋₂₂-alkyl or —C(CH₃)₂—C₆H₅ and

R⁷ is hydrogen, C₁₋₂₂-alkyl, hydroxyl, or alkoxy, and

Y′ and n are as defined above.

Particularly preferred radicals R are the radicals R″ which have one of the formulae a to g

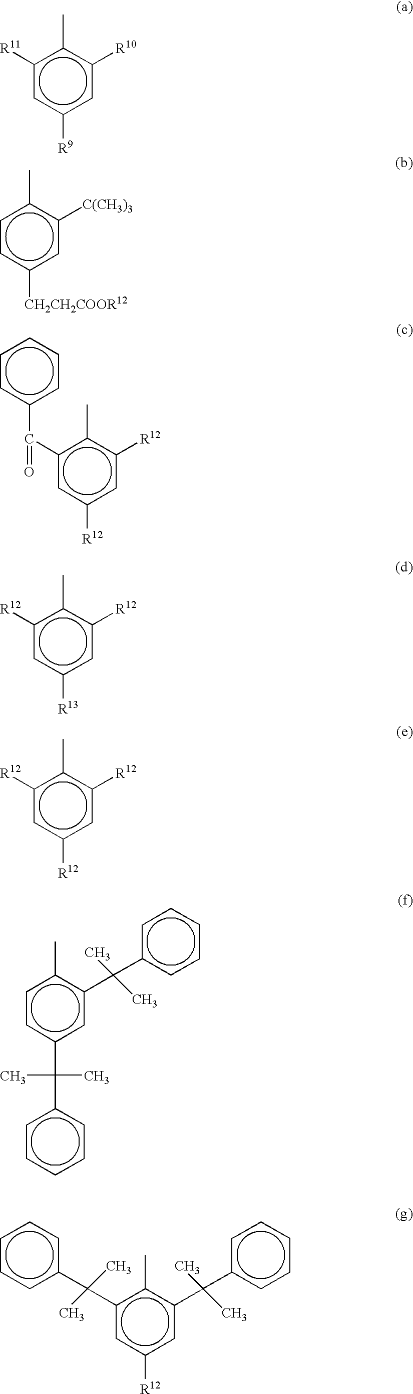

where

R⁹ is hydrogen, C₁₋₈-alkyl, C₁₋₈-alkoxy, phenyl, C₁₋₈-alkylphenyl, or phenyl-C₁₋₈-alkylphenyl, or phenyl-C₁₋₄-alkyl,

R¹⁰ and R¹¹, independently of one another, are hydrogen, C₁₋₂₂-alkyl, phenyl, or C₁₋₈-alkylphenyl,

R¹² is hydrogen or C₁₋₈-alkyl, and

R¹³ is cyano, carboxy, or C₁₋₈-alkoxycarbonyl.

Among the groups of formula a, preference is given to

2-tert-butylphenyl, 2-phenylphenyl,

2-(1′,1′-dimethylpropyl)phenyl, 2-cyclohexylphenyl,

2-tert-butyl-4-methylphenyl, 2,4-di-tert-amylphenyl,

2,4-di-tert-butylphenyl, 2,4-diphenylphenyl,

2,4-di-tert-octylphenyl, 2-tert-butyl-4-phenylphenyl,

2,4-bis(1′,1′-dimethylpropyl)phenyl,

2-(1′-phenyl-1′-methylethyl)phenyl,

2,4-bis(1′-phenyl-1′-methylethyl ) phenyl and

2,4-di-tert-butyl-6-methylphenyl.

Processes for preparing the phosphonites E) can be found in DE-A 40 01 397, and the amounts of these which may be present in the molding compositions are from 0.001 to 5% by weight, preferably from 0.01 to 3% by weight. Other phosphorus-containing stabilizers which may be mentioned, the amounts being those mentioned above, are inorganic compounds of phosphoric acid, preference being given here to alkaline earth metals or alkali metals. Particular preference is given to zinc phosphate and zinc dihydrogenphosphate.

Colorants which may be added are inorganic pigments, such as ultramarine blue, iron oxide, zinc sulfide, titanium dioxide, and carbon black, and also organic pigments, such as phthalocyanines, quinacridones, and perylenes, and dyes, such as nigrosine and anthraquinones.

Nucleating agents which may be used as sodium phenylphosphinate, alumina, silica, and preferably talc.

Other lubricants and mold-release agents, which are usually used in amounts of up to 1% by weight, are preferably long-chain fatty acids (e.g. stearic acid or behenic acid), salts of these (e.g. calcium stearate or zinc stearate), or montan waxes (mixtures of straight-chain saturated-carboxylic acids having chain lengths of from 28 to 32 carbon atoms), or salts thereof with alkaline earth metals or with alkali metals, preferably Ca montanate and/or Na montanate, or else low-molecular-weight polyethylene waxes or low-molecular-weight polypropylene waxes.

Examples of plasticizers which may be mentioned are dioctyl phthalates, dibenzyl phthalates, butyl benzyl phthalates, hydrocarbon oils, and N-(n-butyl)benzenesulfonamide.

The thermoplastic molding compositions of the invention may be prepared by processes known per se, by mixing the starting components in conventional mixers, such as extruders, Brabender mixers, or Banbury mixers, followed by extrusion. The extrudate may be cooled and comminuted. It is also possible to premix individual components and then to add the remaining starting materials, either individually or likewise mixed. The mixing temperatures are generally from 230 to 290° C.

In one preferred method of operation, components B) to C) may be mixed with a polyester prepolymer, compounded, and pelletized. The resultant pellets are then condensed in the solid phase under an inert gas, continuously or batchwise, at a temperature below the melting point of component A) until the desired viscosity has been reached.

The thermoplastic molding compositions of the invention have good crystallization behavior over prolonged periods and on repeated melting, and also good flame retardancy. To a very substantial extent, processing proceeds without alteration of the polymer matrix (coloration). The molding compositions also have good molecular weight stability during processing, and lower cycle times and demolding times. They are suitable for producing fibers, films, or moldings, in particular for applications in the electrical and electronics sectors. These applications are in particular lamp parts, such as lamp sockets and lamp holders, plugs, muiltipoint connectors, coil formers, casings for capacitors or connectors, and circuit-breakers, relay housings, and reflectors, cooling fan wheels, PC components, and casings for transformers.

### EXAMPLES

Component a₁: polybutylene terephthalate with a viscosity number of 130 ml/g and a carboxy end group content of 25 mval/kg (VN measured in 0.5% strength by weight solution of phenol/o-dichlorobenzene, 1:1 mixture at 25° C. to ISO 1628), comprising, based on a1), 0.65% by weight of pentaerythritol tetrastearate (component E1),

Component a₂: PET with a VN of 76 ml/g.

Component b₁

Tetrabromobisphenol A oligocarbonate n˜4-5 (BC 52/58 from the company Great Lakes) Mₙ≈2500

Component b₂

Antimony trioxide (in the form of 90% strength concentrate in polyethylene)

Component C1

KH₂PO₄

Component C2

LiH₂PO₄

Component Cc

Zn(H₂PO₄)₂

Component D1

Polytetrafluoroethylene (Teflon) in the form of a 40% strength aqueous dispersion

Component D2

PTFE/SAN (50:50) Blendex® 449 from the company General Electric Plastics GmbH

Component E2

Chopped glass fiber with average length of 4 mm (epoxysilanized size)

Component E3

Carbon black (Printex® 60 from Degussa AG) in the form of a 25% strength masterbatch in PBT

Preparation of Molding Compositions

Components A) to E) were mixed at 260° C. in an extruder, in the quantitative proportions given in the table, homogenized, pelletized, and dried.

Flowability was measured by means of a spiral test at 260 and, respectively, 270° C. melt temperature, and 60 and, respectively, 80° C. mold temperature. The hold pressure was 1 000 bar.

Impact strength was measured on test specimens to ISO 179/leA at 23 and −30° C. Crystallization behavior was determined using DSC measurements, TM2 being the temperature after the following temperature progression in the DSC test:

1) holding at 40° C. for 3 min,

2) heating from 40 to 270° C. at 20° C./min,

3) holding at 270° C. for 1 min,

4) cooling from 270 to 40° C., using 20° C./min steps,

5) holding at 40° C. for 1 min, and

6) heating from 40 to 270° C. for a second time, using 20° C./min steps.

TS2 was the temperature after the following steps of the test:

1) producing an injection molding at 270° C. melt temperature and 80° C. mold temperature

the dimensions of the dumbbell tensile specimen were 80×10×4 mm in the central section and 170×20×4 mm for the outer section.

2) DSC test, using the individual steps mentioned above

The makeup of the molding compositions and the results of the tests are given in the table.

| Example | 1 | 2 | 1c | 2c | 3c | 4c |
|---|---|---|---|---|---|---|
| Makeup. [% by weight] | 36.3 + 0.5 | 36.4 + 0.5 | 32.45 + 0.5 | 32.45 + 0.5 | 36.8 + 0.35 | 36.3 + 0.5 |
| a₁ + E1 | | | | | | |
| a₂ | 15 | 15 | 15 | 15 | 20 | 15 |
| b₁ | 12 | 12 | 12 | 12 | 12.5 | 12 |
| b₂ | 5.5 | 5.5 | 5.5 | 5.5 | 5.8 | 5.5 |
| C1 | 0.2 | — | 0.2 Cc | 0.2 Cc | 0.2 Cc | 0.2 Cc |
| C2 | — | 0.1 | — | 0- | — | — |
| D1 | — | — | 0.35 | 0.35 | 0.35 | — |
| D2 | 0.5 | 0.5 | — | — | — | 0.5 |
| E2 | 30 | 30 | 30 | 30 | 20 | 30 |
| E3 | — | — | — | 4 | 4 | — |
| Spiral test 260°/60° | 27.4 | 27 | 23.5 | 28.8 | 28.5 | 24.8* |
| Spiral test 270°/80° | 33.1 | 31.8 | 29.7 | 36.1 | 37.1 | — |
| Charpy +23° C. [kJ/m²] | 9.5 | 8.2 | 7.6 | 4.5 | 5.3 | 7.0 |
| Charpy −30° C. [kJ/m²] | 8.2 | 7.6 | 7.1 | — | — | — |
| TM2 [° C.] | 216.7 | 209 | 205.9 | — | — | 205.5 |
| | 238.7 | | | | | |
| TS2 [° C.] | 216.7 | 207.3 | — | — | — | — |
| | 237.7 | | | | | |

*Spiral test 260°/80°

We claim:

1. A thermoplastic molding composition comprising
A) from 10 to 97% by weight of at least one polyester a₁) other than polyethylene terephthalate (PET), which comprises, based on 100% by weight of A), from 1 to 50% by weight of PET a₂),
B) from 1 to 30% by weight of a flame retardant combination made from, based on 100% by weight of B),
b₁) from 20 to 99% by weight of a halogen-containing flame retardant, and
b₂) from 1 to 80% by weight of an antimony oxide,
C) from 0.01 to 5% by weight of KH₂PO₄ or LiH₂PO₄, or a mixture of these
D) from 0.01 to 3% by weight of an antidrop agent, and
E) from 0 to 70% by weight of other additives, where the total of the percentages by weight of components A) to E) is 100%.

2. A thermoplastic molding composition as claimed in claim 1, in which component a₁) is composed of a polyalkylene terephthalate having from 2 to 10 carbon atoms in the alkyl moiety.

3. A thermoplastic molding composition as claimed in claim 1 or 2, comprising from 1 to 50%by weight of a fibrous or particulate filler E), or a mixture of these.

4. A thermoplastic molding composition as claimed in any of claims 1 to 3, in which b₂) is composed of an antimony trioxide or antimony pentoxide, or a mixture of these.

5. A thermoplastic molding composition as claimed in any of claims 1 to 3, in which component b₂) is added in the form of masterbatch in a thermoplastic.

6. A thermoplastic molding composition as claimed in claim 5, in which the thermoplastic is a polyolefin.

7. A thermoplastic molding composition as claimed in any of claims 1 to 6, in which component D) is composed of a polymer of ethylene having a fluorine content of from 55 to 76% by weight, based on D).

8. The use of the thermoplastic molding composition as claimed in any of claims 1 to 7 for producing fibers, films, or moldings.

9. A molding obtainable from the thermoplastic molding compositions as claimed in any of claims 1 to 7.

10. A coil housing, a coil former, a coil support, a capacitor cup, a plug connector, a multipoint connector, a plug bridge, a chip carrier, a printed circuit board, a lamp part, a lamp holder, a starter housing, a transformer housing, a battery housing, a cooling fan wheel, a housing for cooling fan wheels, a lamp socket, a protective covering for lamps, a lamp support, a light switch, a small electrical device, a housing for a clothes iron, a switching system, a circuit breaker, a charger, a plug socket, a component of a motor, a component of a generator, or a terminal strip obtainable from the thermoplastic molding compositions as claimed in any of claims 1 to 7.
